(19) United States
(12) Patent Application Publication
(10) Pub. No.: US 2025/0232302 A1
(43) Pub. Date: Jul. 17, 2025

(54) MOBILE DEVICE ACCESS PROTECTION

(71) Applicant: Motorola Mobility LLC, Chicago, IL (US)

(72) Inventors: Rafael Matuo, Sumaré (BR); Luis Fernando Momente, Campinas (BR); Nicolas Riccieri Gardin Assumpcao, Campinas (BR); João Pedro Marcolino Cordeiro, Campinas (BR); Amit Kumar Agrawal, Bangalore (IN)

(73) Assignee: Motorola Mobility LLC, Chicago, IL (US)

(21) Appl. No.: 18/409,995

(22) Filed: Jan. 11, 2024

(51) Int. Cl. G06Q 20/40

(52) U.S. Cl. CPC G06Q 20/4016; G06Q 20/4015; G06Q 20/409

(57) ABSTRACT

In aspects of mobile device access protection, a mobile device implements a performance degradation manager that can detect one or more contextual triggers that indicate at least one potential risk event, such as an unauthorized attempt to access a device application. Based on the one or more contextual triggers, the performance degradation manager performs a degradation protocol that limits access to one or more functions of the mobile device, where the one or more functions would normally provide access to personal information and/or a device application. The degradation protocol includes the appearance of a malfunction of the device, such as an application update, a touchscreen malfunction, a display malfunction, a connection malfunction, a power failure, and/or a redirection.

### BACKGROUND

Mobile devices, particularly mobile phone devices, continue to provide users with functionality to accomplish more and more. The devices can provide the ability to communicate, perform research, play games, make documents, transfer information, accomplish banking tasks, buy goods and services, book reservations and so on. With this functionality, it has become quite normal for these devices to store or otherwise provide access to confidential information and, in some instances, provide access to personal property (e.g., money in bank accounts). While such access is typically convenient and efficient for an authorized user of the device, unauthorized access to the device can be problematic. For example, a thief may gain access to a digital device and use the digital device to unlawfully transfer funds to an account controlled by the thief. While many of these devices require entry of password or passcode to access the device, or to access certain functionality of the device, a thief may be able to force an authorized user of the device to provide such information. In turn, the thief can then gain access to, for example, personal accounts, purchasing applications, and so on. In this situation and others, it can be very difficult to inhibit access to the device or applications of the device by unauthorized individuals.

### BRIEF DESCRIPTION OF THE DRAWINGS

Implementations of the techniques for mobile device access protection are described with reference to the following Figures. The same numbers may be used throughout to reference like features and components shown in the Figures.

FIG. 1 illustrates an example system for mobile device access protection in accordance with one or more implementations as described herein.

FIG. 2 further illustrates an example of mobile device access protection in accordance with one or more implementations as described herein.

FIG. 3 illustrates a flowchart showing example operation of mobile device access protection in accordance with one or more implementations as described herein.

FIGS. 4 and 5 illustrate example methods for mobile device access protection in accordance with one or more implementations of the techniques described herein.

FIG. 6 illustrates various components of an example device that may be used to implement the techniques for mobile device access protection as described herein.

### DETAILED DESCRIPTION

Various implementations of the techniques for mobile device access protection may be implemented as described herein. A mobile device, such as any type of a wireless device, media device, mobile phone, flip phone, client device, tablet, computing, communication, entertainment, gaming, media playback, and/or any other type of computing, consumer, and/or electronic device, or a system of any combination of such devices, may be configured to perform techniques for mobile device access protection as described herein. In one or more implementations, a mobile device includes a performance degradation manager, which can be used to implement aspects of the techniques for mobile device access protection.

Safeguarding information and personal property is an ongoing concern for people, corporations, and the like. The use of mobile devices in the digital age has elevated this concern since it allows information and property (e.g., money) to now be accessed and/or moved with a few clicks, swipes, codes, and so on using a mobile device. Moreover, the access provided by these mobile devices travels with the people that carry them.

While passwords, passcodes, facial recognition, two-step authentication, and the like provide significant protection against unauthorized access to information and property, none of these typically provides protection against an unauthorized user (e.g., a criminal and/or thief) demanding that a user of a mobile device provide the unauthorized user with access to the device and its applications. For example, a thief can, with threat of bodily harm or otherwise, demand that a device user provide the thief with passwords, passcodes, or the like, as well as demand that the device user enter passwords, passcodes, use his or her face for facial recognition, or even perform a two-step authentication to provide such access. There is little presently available to protect against this type of unauthorized, stolen access. Moreover, once access is provided, the unauthorized user can perform a variety of operations to copy confidential information and/or steal personal property.

For instance, a device user may be using his or her mobile device to find a hotel at night in an area that the user is newly visiting. The device user is defenseless and needs to walk along several unpopulated streets to get to the hotel. During the walk, a thief approaches the user, demands that the user hand over the mobile device and provide the thief with the necessary information to access a banking application or payment application on the mobile device. In this scenario, the device user will typically provide the device and the information to the thief and there is very little that can then stop the thief from accessing a banking application on the device and transferring money to an account that the thief controls. The ability to stop the thief from transferring this money would be particularly desirable.

Accordingly, aspects of the techniques for mobile device access protection can be implemented to help safeguard access to a mobile device and/or its applications in this scenario and others. In particular, a mobile device is provided that, in response to contextual triggers, the mobile device initiates and/or performs one or more degradation protocols that limit access to the mobile device and/or to device applications on the mobile device. Advantageously, this type of protocol can provide protection against access where other techniques (e.g., passwords, passcodes, and so on) are ineffective.

In aspects of the described techniques, a mobile device includes a performance degradation manager that implements monitoring of contextual conditions for detection of one or more contextual triggers that indicate a potential risk event. Then, based on the one or more contextual triggers, the performance degradation manager implements a degradation protocol limiting access to one or more functions of the mobile device (e.g., device applications on the mobile device and/or access to the mobile device itself), where the one or more functions of the mobile device normally provide access to personal information and/or device applications. Based on the performance degradation manager detecting one or more contextual triggers, the performance degradation manager can initiate and/or perform a degradation protocol that limits access to the one or more functions of the mobile device.

In some implementations, the mobile device access protection is provided as a method. The method includes monitoring contextual conditions associated with a mobile device and detecting, based on the monitoring of the contextual conditions, one or more contextual triggers indicating a potential risk event. Based on an occurrence of the contextual trigger, a degradation protocol is initiated and/or performed to limit access to the one or more functions of the mobile device. Again, it is typical that the one or more functions of the mobile device normally provide access to personal information and/or device application access.

While features and concepts of the described techniques for mobile device access protection can be implemented in any number of different devices, systems, environments, and/or configurations, implementations of the techniques for mobile device access protection are described in the context of the following example devices, systems, and methods.

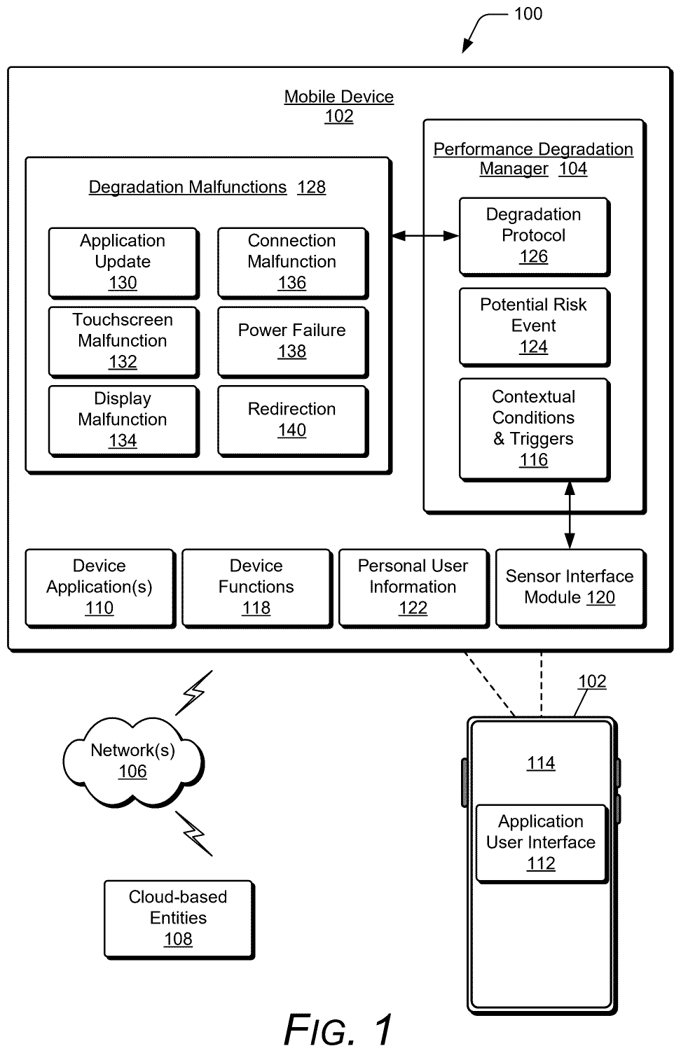

FIG. 1 illustrates an example system 100 for mobile device access protection, as described herein. The system 100 includes a mobile device 102, a performance degradation manager 104 implemented by the mobile device, and a communication network 106. Examples of the mobile device 102 include any type of a wireless device, mobile device, mobile phone, flip phone, client device, companion device, tablet, computing device, communication device, entertainment device, gaming device, media playback device, any other type of computing, consumer, and/or electronic device.

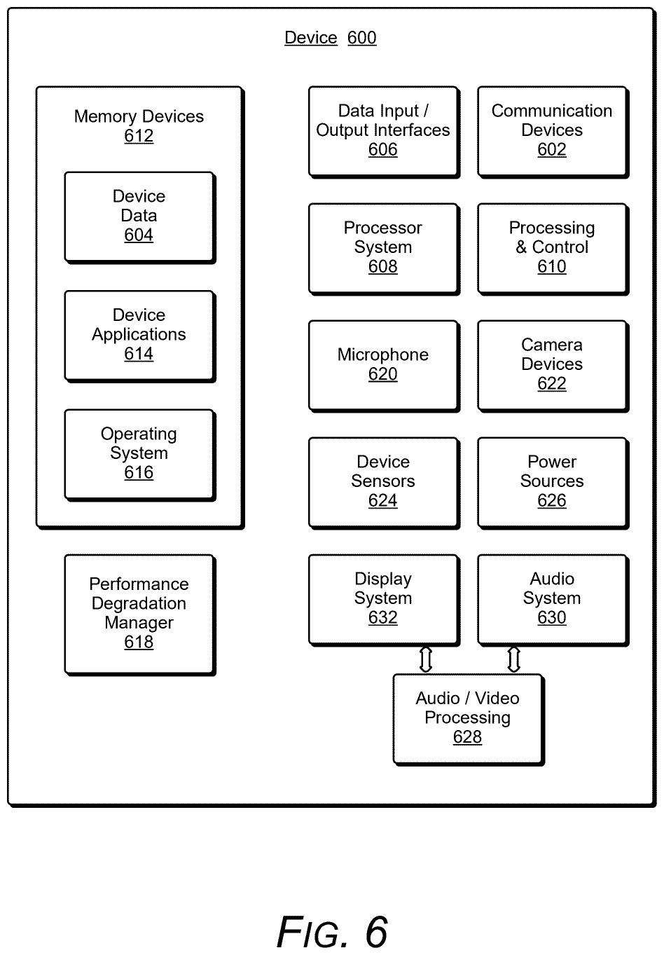

The mobile device 102 can be implemented with various components, such as a processor system and memory, as well as any number and combination of different components as further described with reference to the example device shown in FIG. 6. In implementations, the mobile device 102 includes various radios for wireless communication with other devices. For example, the mobile device 102 can include at least one of a Bluetooth (BT) and/or Bluetooth Low Energy (BLE) transceiver, as well as a near field communication (NFC) transceiver, or the like. In some cases, the mobile device 102 includes at least one of a WiFi radio, a cellular radio, a global positioning satellite (GPS) radio, or any available type of device communication interface.

In some implementations, the devices, applications, modules, servers, and/or services described herein communicate via the communication network 106, such as for data communication between the mobile device 102 and various cloud-based entities 108, such as devices, services, servers, and/or systems in the network cloud. The communication network 106 can include a wired and/or a wireless network. The communication network 106 is implemented using any type of network topology and/or communication protocol and is represented or otherwise implemented as a combination of two or more networks, to include IP-based networks, cellular networks, and/or the Internet. The communication network 106 includes mobile operator networks that are managed by a mobile network operator and/or other network operators, such as a communication service provider, mobile phone provider, and/or Internet service provider.

The mobile device 102 includes various functionalities that enable the device to implement different aspects of mobile device access protection, as described herein. For example, the mobile device 102 can include a connectivity module and/or a device interface module, as generally described with reference to the example device shown in FIG. 6. The connectivity module represents functionality (e.g., logic, software, and/or hardware) enabling the mobile device 102 to interconnect with the cloud-based entities 108 and/or other devices, systems, and networks. For example, the connectivity module enables wireless and/or wired connectivity of the mobile device 102. The device interface module represents functionality enabling the mobile device 102 to interface with other devices and/or applications of the mobile device 102, and the device interface module can include one or more device settings and/or device configurations of the mobile device.

In one or more implementations, the mobile device 102 includes and implements one or more device applications 110, such as any type of financial technology application, payment application, photo application, messaging application, email application, video communication application, cellular communication application, music/audio application, gaming application, media application, social platform application, and/or any other of the many possible types of device applications. Many of the device applications 110 have an associated application user interface 112 that is generated and displayed for user interaction and viewing, such as on a display device 114 of the mobile device 102. Generally, an application user interface, or any other type of video, image, graphic, graphical code and the like is digital image content that is displayable on the display of the mobile device 102.

In the example system 100 for mobile device access protection, the mobile device 102 provides performance degradation functionality. The mobile device 102 implements the performance degradation manager 104 for initiating, performing, ending, or otherwise controlling performance degradation of the mobile device 102, and for monitoring and detecting contextual conditions and triggers 116. As used herein, “performance degradation” refers to actual and/or simulated performance degradation and “degradation” can refer to the performance of normal device functions 118 of the mobile device 102, but performed in response to and/or based on the contextual conditions and triggers. For example, performance degradation can be an actual update or simulated update of a device application 110 based on one or more of the contextual triggers 116. The performance degradation manager 104 represents functionality (e.g., logic, software, and/or hardware) enabling implementation of the described techniques for mobile device access protection. In one or more examples, the performance degradation manager 104 can be implemented as computer instructions stored on computer-readable storage media and executed by a processor system of the mobile device 102. Alternatively or in addition, the performance degradation manager 104 is implemented at least partially in hardware of a device.

In one or more implementations, the performance degradation manager 104 includes independent processing, memory, and/or logic components functioning as a computing and/or electronic device integrated with the mobile device 102. Alternatively or in addition, the performance degradation manager 104 can be implemented in software, in hardware, or as a combination of software and hardware components. In one or more examples, the performance degradation manager 104 is implemented as a software application or module, such as executable software instructions (e.g., computer-executable instructions) that are executable with a processor system of the mobile device 102 to implement the techniques and features described herein. As a software application or module, the performance degradation manager 104 is stored on computer-readable storage memory (e.g., memory of a device), or in any other suitable memory device or electronic data storage implemented with the module. Alternatively or in addition, the performance degradation manager 104 is implemented in firmware and/or at least partially in computer hardware. For example, at least part of the performance degradation manager 104 is executable by a computer processor, and/or at least part of the performance degradation manager 104 is implemented in logic circuitry. In at least one implementation the performance degradation manager 104 can be implemented as part of and/or in conjunction with an operating system of the mobile device 102.

In implementations, the performance degradation manager 104 can include or utilize a sensor interface module 120 to implement monitoring and/or detecting of the contextual conditions and triggers 116. In this example, the performance degradation manager 104 provides device access protection functionality for the mobile device 102, the device applications 110, the device functions 118, and/or personal user information 122 of the user of the device based at least in part on the operations of the sensor interface module 120.

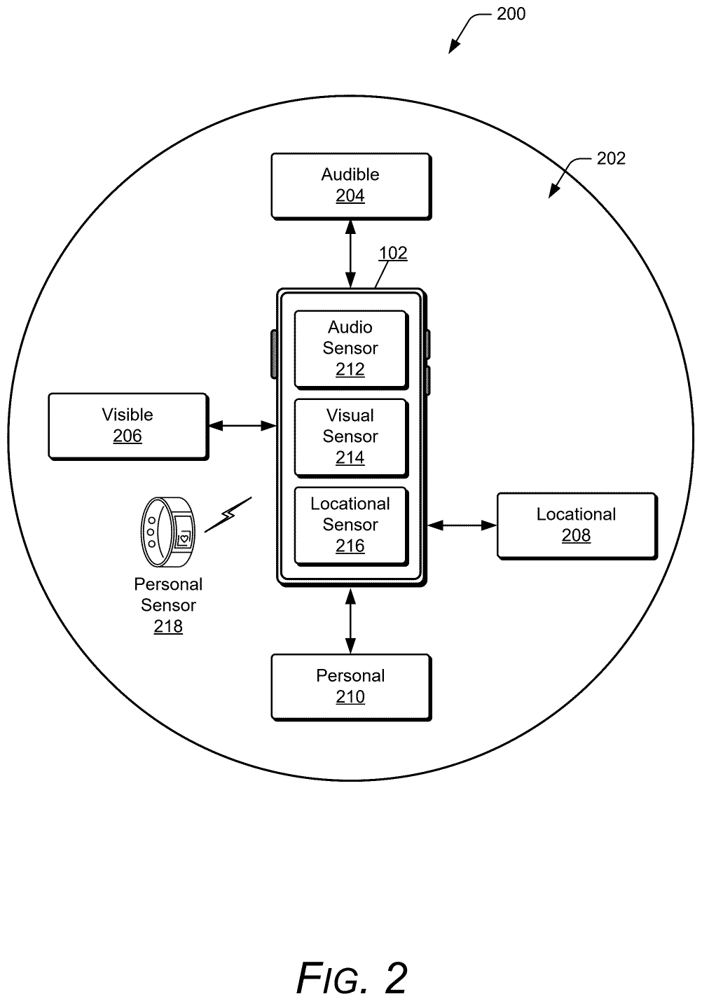

In aspects of the techniques described for mobile device access protection, performance degradation of various device functions 118 and/or the device applications 110 can be implemented on the device in an unsafe device context. In implementations, the performance degradation manager 104 can detect one or more of the contextual conditions and/or triggers 116 that indicate a potential risk event 124, such as an unauthorized attempt to access a device application 110 (e.g., a banking or financial application) that allows money to be transferred. The contextual conditions and/or triggers 116 can include an audible contextual trigger, a visual contextual trigger, a locational contextual trigger, and/or a personal contextual trigger, as further shown and described with reference to FIG. 2. In implementations, the performance degradation manager 104 can detect the one or more contextual triggers 116 by use of a microphone of the mobile device 102, a camera of the mobile device, and/or a geolocation feature of the mobile device.

Based on detecting a contextual trigger 116, the performance degradation manager 104 can then initiate to perform a degradation protocol 126 that limits access to one or more of the device functions 118 of the mobile device 102. The device functions normally provide access to the personal user information 122 of the user of the device and/or access to the device applications 110. To perform the degradation protocol 126, the performance degradation manager 104 can select at least one of multiple degradation malfunctions 128 based on the contextual triggers 116 that are detected. For example, the degradation malfunctions 128 can include an appearance of a device malfunction selected from any one or more of application updates 130, a touchscreen malfunction 132, a display malfunction 134, a connection malfunction 136, a power failure 138, a redirection 140, and/or any other type of perceived or actual “device malfunction”. If the performance degradation manager 104 subsequently detects a lack of a potential risk event, the performance degradation manager can then nullify the degradation protocol 126, returning the mobile device 102 to normal device operation. The performance degradation manager 104 can detect subsequent contextual triggers that may include a low-risk location of the device, or that the personal user information 122 and/or access to the device applications 110 has been secured.

In implementations, the performance degradation manager 104 can detect an unsafe context and enable random degradation policies to prevent access to any meaningful operation, including access to personal information that may be stored on and/or accessible from the mobile device 102. The randomness and pace of the random degradation policies would also help to prevent an intruder from perceiving these as a security feature. An unsafe context trigger can be detected to enable the security features, such as to detect a user with the mobile device 102 in an unsafe zone (e.g., using artificial intelligence (AI) with geofencing, Wi-Fi access points, Bluetooth, and/or UWB); by using face and/or audio recognition for people surrounding the user at a time when the user is unlocking the device; if a current user is detected as untrustworthy (e.g., via face recognition); and/or the user of the mobile device has manually triggered the security features, such as by use of a dedicated PIN or fingerprint configured to enable the security features.

In implementations, the performance degradation manager 104 can gradually enable the degradation policies to prevent access to the device applications 110, services and functions of the device, and/or the personal user information 122. The performance degradation manager 104 can initiate the degradation protocol 126 to fake a mandatory application update and force the mobile device to close or turn-off; fake touchscreen issues or malfunction by randomly not responding to screen touches; fake a broken or inoperable display with low screen brightness, black spots, and/or green lines in random positions; fake network degradation, such as by blocking specific domains and connections, limiting bandwidth, and dropping to a less functional network (e.g., a 2G connection); fake a low battery charge and eventually power down the phone; and/or a redirection to random advertisements while using a device application. In implementations, the performance degradation can be restricted per context, either to the entire device, only for specific applications, or via preconfigured settings.

In one or more implementations, the performance degradation manager 104 is implemented using a machine learning (ML) model or algorithm (e.g., a neural network, artificial intelligence (AI) algorithms). The performance degradation manager 104 implemented as a machine learning model may include AI, a ML model or algorithm, a convolutional neural network (CNN), and/or any other type of machine learning model to implement features of the mobile device access protection. As used herein, the term “machine learning model” refers to a computer representation that is trainable based on inputs to approximate unknown functions. For example, a machine learning model can utilize algorithms to learn from, and make predictions on, inputs of known data (e.g., training and/or reference images) by analyzing the known data to learn to generate outputs. In the example system 100, the performance degradation manager 104 can detect the one or more contextual triggers 116 by analyzing, using a trained machine learning module, contextual conditions to determine a likelihood of the potential risk event 124.

FIG. 2 illustrates an example 200 of mobile device access protection, as described herein. In this example 200, the mobile device 102 is monitoring contextual conditions in an environment 202, or surrounding, or related to the mobile device 102. The contextual conditions can include any combination of audible contextual conditions 204, visible contextual conditions 206, locational contextual conditions 208, personal contextual conditions 210, and so on.

In one or more implementations, the mobile device 102 includes (or communicates with) an audio sensor 212 for monitoring the audible contextual conditions 204. The mobile device 102 can include a microphone used as the audio sensor 212. Additionally or alternatively, the audio sensor 212 may be a microphone within a headset, a watch, or other device that is in communication with the mobile device 102 and/or a different or alternative microphone. It is further contemplated that one or more alternative audio sensors can be included as part of the audio sensor 212, or the audio sensor can include any combination of the aforementioned audio sensors.

In one or more implementations, the mobile device 102 includes (or communicates with) a visual sensor 214 for monitoring the visible contextual conditions 206. The mobile device 102 can include a camera used as the visual sensor 214. This can be the same camera that is typically used for pictures and/or video with the mobile device 102, or can be an alternative camera. Additionally or alternatively, the visual sensor 214 may be a camera separate from mobile device 102, but in communication with the mobile device 102 and/or a different or alternative camera. It is further contemplated that one or more alternative visual sensors can be included as part of the visual sensor 214, or the visual sensor can include any combination of the aforementioned visual sensors.

In one or more implementations, the mobile device 102 includes (or communicates with) a locational sensor 216 for monitoring the locational contextual conditions 208. The mobile device 102 can include a global positioning system (GPS) that is used as the locational sensor 216. Additionally or alternatively, the locational sensor 216 can include a GPS separate from mobile device 102, but in communication with the mobile device 102.

In one or more implementations, the mobile device 102 can also include or communicate with a personal sensor 218 for monitoring the personal contextual conditions 210. As one example, a user of the mobile device 102 may wear a smart watch, an exercise monitor, or any other type of wearable device that monitors biometric and other data of the person carrying or wearing the wearable device. Such devices are typically separate from but in communication with the mobile device 102. Additionally or alternatively, it is contemplated that a personal sensor 218 can be integrated with the mobile device 102 for sensing personal contextual conditions 210 (e.g., biometric data) of the individual holding the mobile device 102. It is further contemplated that one or more alternative personal sensors can be included as part of the personal sensor 218 or the personal sensor can include any combination of the aforementioned personal sensors.

Generally, the performance degradation manager 104 can monitor the various contextual conditions for changes that are designated as contextual triggers, or any occurrences of particular contextual conditions that are designated as the contextual triggers 116. Upon sensing of one or more contextual triggers, the performance degradation manager 104 can determine if and/or when to initiate and/or perform a degradation protocol 126. The degradation protocol can be initiated and/or performed upon the occurrence of at least one contextual trigger, but may also be initiated and/or performed upon the occurrence of a combination of the contextual triggers. The contextual triggers can be categorized in correspondence with the various contextual conditions that are monitored. Thus, changes in the audible contextual conditions 204 that are designated as contextual triggers, or any occurrences of particular audible contextual conditions 204 that are designated as contextual triggers, can be referred to as the audible contextual triggers. Changes in the visible contextual conditions 206 that are designated as contextual triggers, or any occurrences of particular visible contextual conditions 206 that are designated as contextual triggers, can be referred to as the visible contextual triggers. Changes in the locational contextual conditions 208 that are designated as contextual triggers, or any occurrences of particular locational contextual conditions 208 that are designated as contextual triggers, can be referred to as the locational contextual triggers. Changes in the personal contextual conditions 21 that are designated as contextual triggers, or any occurrences of particular personal contextual conditions 210 that are designated as contextual triggers, can be referred to as personal contextual triggers.

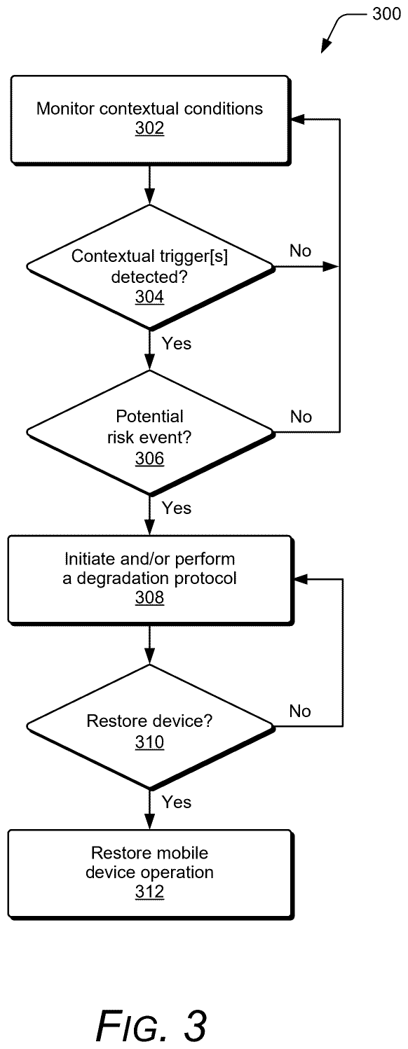

FIG. 3 illustrates an example of a flowchart 300 of one example of operation of mobile device access protection, as described herein. In this example at 302, contextual conditions associated with the mobile device 102 are monitored for determining, at 304, if one or more contextual triggers are detected. If no contextual triggers are detected, then the mobile device 102 continues to monitor for the contextual conditions at 302. If one or more contextual triggers are detected at 304, then the mobile device 102 determines, at 306, if the one or more contextual triggers indicate a likelihood of a potential risk event. If there is no likelihood of a potential risk event, then the mobile device 102 returns to monitoring for the contextual conditions at 302. If one or more of the contextual triggers do indicate a likelihood of a potential risk event, then the mobile device 102 initiates and/or performs a degradation protocol at 308. Then, at 310, a determination is made as to whether it is desirable to restore the mobile device 102 to normal operation and function. If no, then the mobile device 102 continues the selected degradation protocol at 308. If yes, then the mobile device 102 is restored to normal device operation and functions at 312.

Contextual triggers are typically indicative of a potential risk event. A potential risk event, as used herein, is any potential unauthorized access to the mobile device 102, or to an application of the mobile device, or access by an authorized device user of the mobile device who is being coerced to access the mobile device or an application of the mobile device. The contextual triggers can also indicate that unauthorized use of the mobile device by an unauthorized user is for the purpose of obtaining confidential information or user personal property.

Audible contextual triggers include any changes that are detected in the audible contextual conditions 204, which are designated as audible contextual triggers, or as any occurrences of the audible contextual conditions 204 that are designated as audible contextual triggers. Examples of audible contextual conditions include, without limitation: commands to provide access to the mobile device and/or an application of the mobile device; threats of violence; commands to provide access information (e.g., passwords) related to the mobile device and/or an application of the mobile device; and/or any other type of additional audible contextual triggers usable according to the techniques described herein.

Visible contextual triggers include any changes that are detected in the visible contextual conditions 206, which are designated as visible contextual triggers, or as any occurrences of the visible contextual conditions 206 that are designated as visible contextual triggers. Examples of visible contextual conditions include, without limitation: presence of unknown individuals, presence of a weapon, presence of uncommon surroundings, and/or any other type of additional visible contextual triggers usable according to the techniques described herein.

Locational contextual triggers include any changes that are detected in the locational contextual conditions 208, which are designated as locational contextual triggers, or as any occurrences of the locational contextual conditions 208 that are designated as visible contextual triggers. Examples of locational contextual conditions include, without limitation: a location of the mobile device in a new location, unusual movement of the mobile device, a location of the mobile device in an area of criminal activity, and/or any other type of additional locational contextual triggers usable according to the techniques described herein.

Personal contextual triggers include any changes that are detected in the personal contextual conditions 210, which are designated as personal contextual triggers, or as any occurrences of the personal contextual conditions 210 that are designated as personal contextual triggers. Examples of personal contextual conditions can include any change in biometric data indicating stress, such as a rapid upturn in heartbeats, a rapid upturn in blood pressure, a rapid increase in breathing, combinations thereof, or the like of an authorized device user of the mobile device. Additional personal contextual triggers may also be usable according to the techniques described herein.

It is contemplated that the mobile device 102 can initiate and/or perform the performance degradation protocol 126 based on a single contextual trigger 116. For example, a demand for a password to access a payment application of the mobile device may provide a significant likelihood of a potential risk event 124 and may cause the mobile device, particularly the performance degradation manager 104, to initiate performance of the degradation protocol. Alternatively, a combination of the contextual triggers 116 may provide a significant likelihood of a potential risk event 124 and may cause the mobile device, particularly the performance degradation manager 104, to initiate performance of a performance degradation protocol. One example of a combination of the contextual triggers that might signal initiation and/or performance of a performance degradation protocol includes a command to provide access to the mobile device and/or an application of the mobile device in combination with any of the other contextual triggers, and particularly in combination with one or more of a threat of violence, a command to provide access information (e.g., passwords) related to the mobile device and/or an application of the mobile device, presence of a weapon and/or a rapid upturn of heartbeats of an authorized device user of the mobile device.

Another example of a combination of the contextual triggers that might signal initiation and/or performance of a performance degradation protocol includes a threat of violence in combination with any of the other contextual triggers, and particularly in combination with one or more of a command to provide access to the mobile device and/or an application of the mobile device; a command to provide access information (e.g., passwords) related to the mobile device and/or an application of the mobile device; presence of a weapon; and/or a rapid upturn of heartbeats of an authorized device user of the mobile device. Yet another example of a combination of the contextual triggers that might signal initiation and/or performance of a performance degradation protocol includes presence of a weapon, and particularly in combination with one or more of a command to provide access to the mobile device and/or an application of the mobile device; a command to provide access information (e.g., passwords) related to the mobile device and/or an application of the mobile device; a threat of violence in combination with any of the other contextual triggers; and/or a rapid upturn of heartbeats of an authorized device user of the mobile device.

In an implementation of the techniques described herein, a machine learning model (e.g., a neural network, AI algorithms) is employed to determine whether, based on the contextual triggers, the degradation protocol is initiated and/or performed. This machine learning model is referred to herein as the initiation machine learning model. The initiation machine learning model may include artificial intelligence (AI), a machine learning (ML) algorithm, a convolutional neural network (CNN), and/or any other type of machine learning model to monitor contextual conditions, detect the contextual triggers, and/or determine whether the degradation protocol is to be initiated and/or performed.

The initiation machine learning model can be included as part of the performance degradation manager 104 or otherwise included in the mobile device 102. The initiation machine learning model can be trained using data from various sources. In one implementation, the initiation machine learning model is provided data in the form of photos, videos, real-life objects, imitation scenarios, or the like. Such data can be provided to the initiation machine learning model prior to use of the mobile device 102 by an authorized device user. Alternatively or additionally, the initiation machine learning model can be trained while it is in use by the authorized device user. The data exposes the initiation machine learning model to the various contextual conditions that are designated as the contextual conditions and triggers 116, as well as standard contextual conditions that are not designated as contextual triggers. In this way, the initiation machine learning model learns to distinguish between standard contextual conditions and contextual triggers that indicate a likelihood of a potential risk event.

It is generally desirable to expose the initiation machine learning model to data that includes contextual triggers associated with a potential risk event and contextual triggers not associated with a potential risk event. For example, the data can include images of weapons being used in hunting scenarios as well as images of weapons being used in an unauthorized attempt to access the mobile device 102 or the device applications 110. In this way, the initiation machine learning model can accurately determine when one or more contextual triggers indicates a relatively high likelihood of a potential risk event or when one or more contextual triggers indicate a relatively low likelihood of a potential risk event.

Once the contextual trigger or triggers are detected by the mobile device, the mobile device initiates and/or performs the degradation protocol 126. The degradation protocol can be carried out in a variety of ways. Typically, the degradation protocol limits access to one or more of the device functions 118 of the mobile device, where the one or more device functions normally provide access to the personal user information 122 or access to the device applications 110. The degradation protocol can limit access to the entire mobile device 102, or can limit access to one or more of the device applications of the mobile device.

In one example implementation, the degradation protocol includes the mobile device 102 powering itself down as a malfunction (i.e., a powering down malfunction). In such an implementation, the mobile device may provide a signal indicating a reason that the mobile device 102 is shutting down. For example, the mobile device 102 can provide a signal having text indicating that the mobile device 102 is shutting down to make updates to one or more of the device applications 110 of the mobile device 102. As another example, the mobile device 102 can provide a signal suggesting that a battery is low followed by powering down the mobile device 102.

In one exemplary implementation, the degradation protocol 126 includes the mobile device 102 exhibiting one or more additional or alternative malfunctions. As one example, the mobile device 102 exhibits the touchscreen malfunction 132 such as being unresponsive to one or more touches of the touchscreen of the mobile device while also being responsive to one or more other touches of the touchscreen. As another example, the display screen of the mobile device 102 can display one or more visual malfunctions, such as a dark screen, spots (e.g., black spots), lines (e.g., green lines), combinations thereof, or the like. in yet another example, the display screen of the mobile device 102 displays one or more indications of a poor network connection, such as by a weak cellular network connection, a lack of one or more specific domains or connections, or the like. As still another example, one or more of the device applications 110 of the mobile device 102 can redirect to alternative digital content, such as advertisements. As another example, for an application that provides access to confidential information or personal property, the mobile device 102 can provide a signal that the application needs to be updated followed by the application providing an indication that it is updating. The skilled artisan will be able to imagine further malfunctions suitable for use in the techniques described herein.

In one or more implementations, the degradation protocol 126 can exhibit one or any combination of the degradation malfunctions 128 as described herein, or others. The one or more malfunctions of the degradation protocol can, upon detection of the one or more contextual triggers 116, be selected randomly, can be pre-selected, or can be based on the one or more contextual triggers that are detected or can be based upon other conditions present before or during the potential risk event. As one example scenario, an authorized device user of the mobile device 102 is using a mapping function of the mobile device to guide the user to a hotel in a geographic location in which the user is unfamiliar and the battery charge is less than 10%. In such a situation, the mobile device 102 may choose a degradation protocol in which the mobile device 102 powers itself down since it is considered more believable that the mobile device 102 would lose power in that scenario rather than the mobile device 102 experiencing an alternative malfunction.

In an implementation of the techniques described herein, a machine learning model (e.g., a neural network, AI algorithms) can be employed to determine whether, based on the contextual triggers and/or the standard contextual conditions, which degradation protocol is to be initiated and/or performed. This machine learning model is referred to herein as the performance machine learning model. The performance machine learning model may be integrated with the initiation machine learning model or may be separate. The performance machine learning model may include artificial intelligence (AI), a machine learning (ML) algorithm, a convolutional neural network (CNN), and/or any other type of machine learning model to monitor contextual conditions, detect the contextual triggers, and/or determine which degradation protocol is to be initiated and/or performed.

The performance machine learning model can be included as part of the performance degradation manager 104 or otherwise included in the mobile device 102. The performance machine learning model can be trained using data from various sources. In one implementation, the performance machine learning model is provided data in the form of photos, videos, real-life objects, imitation scenarios or the like. Such data can be provided to the performance machine learning model prior to use of the mobile device 102 by an authorized user. Alternatively or additionally, the performance machine learning model can be trained while it is in use by an authorized device user of the mobile device. The data exposes the performance machine learning model to contextual conditions and triggers for which different degradation protocols are more appropriate than others. In this way, the machine learning model is trained to choose a degradation protocol based on detection of one or more respective contextual conditions and/or triggers 116 that occur proximate in time (e.g., within one hour, within 30 minutes, within 10 minutes or less) to facilitate the choice to initiate and/or perform a degradation protocol.

In one or more implementations, the mobile device 102 can have a mechanism for discontinuing an ongoing degradation protocol. It is contemplated that such a mechanism could be controlled and operated using multiple different techniques and can be controlled and operated by the performance degradation manager 104 or otherwise by the mobile device 102. In one example, the degradation protocol is stopped and/or the mobile device 102 is returned to its normal mode of operation based on rebooting the mobile device 102. In this example, the mobile device can be configured to restore normal operation of the mobile device 102 only after the passing of a predetermined amount of time (e.g., at least 2 minutes, at least 10 minutes, or at least 30 minutes). In another example, the mobile device 102 continues to monitor the contextual conditions for contextual triggers and, based on a lack of contextual triggers, the mobile device returns to normal function. In yet another example, the mobile device 102 can be restored to normal functions by pressing a particular combination of input buttons of the mobile device 102. In yet another example, the performance degradation manager 104 is configured to cause the mobile device to nullify the degradation protocol based on one or more subsequent contextual conditions indicating a lack of the potential risk event. The one or more subsequent contextual conditions can include at least one of a low-risk location or securing of the personal user information 122 and/or access to the device applications 110.

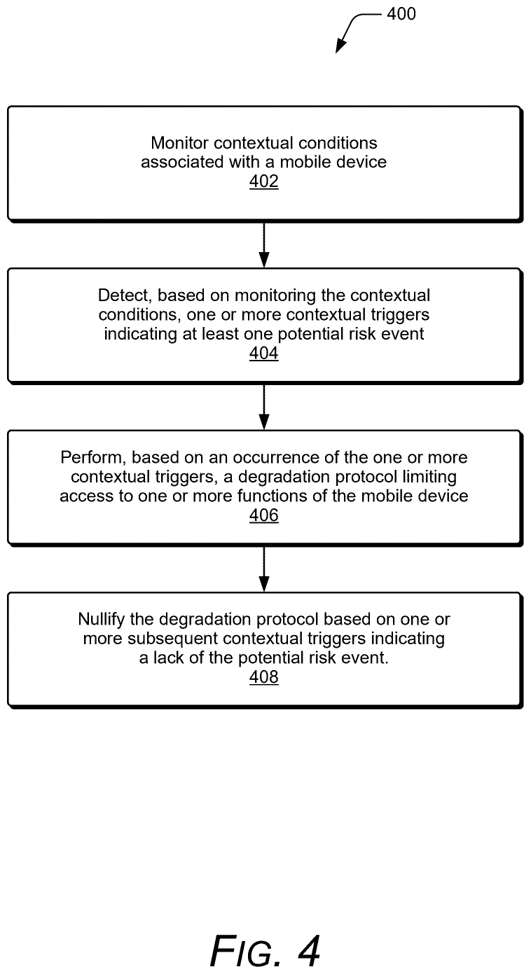

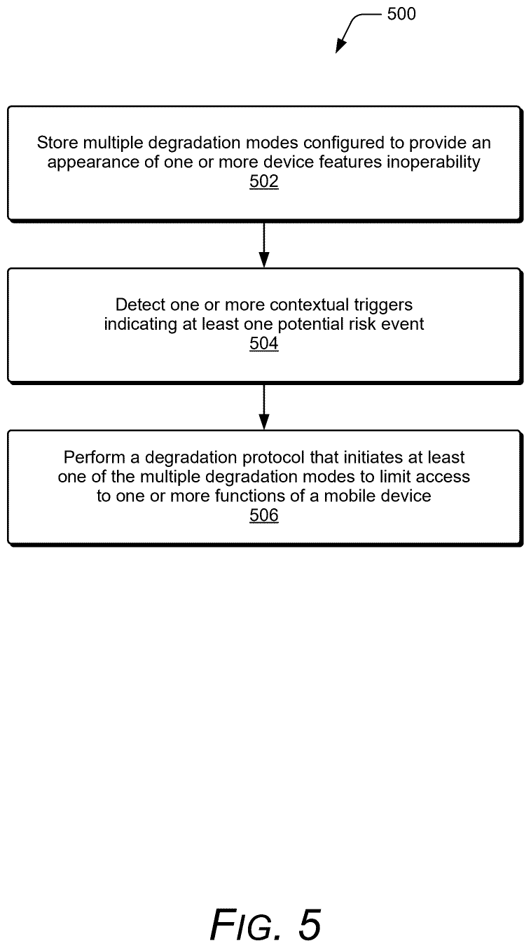

Example methods 400 and 500 are described with reference to respective FIG. 4 and 5 in accordance with one or more implementations of mobile device access protection, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 4 illustrates an example method 400 for mobile device access protection. The order in which the method is described is not intended to be construed as a limitation, and any number or combination of the described method operations may be performed in any order to perform a method, or an alternate method.

At 402, contextual conditions associated with a mobile device are monitored. For example, the performance degradation manager 104 monitors the contextual conditions, particularly the audible contextual conditions 204 and the visible contextual conditions 206. The monitoring is accomplished using an audio sensor 212 (e.g., a microphone) of the mobile device 102 and a visual sensor 214 (e.g., a camera) of the mobile device 102.

At 404, one or more contextual triggers are detected based on the monitoring of the contextual conditions, where the one or more contextual triggers indicate at least one potential risk event. For example, the performance degradation manager 104 detects one or more contextual triggers 116 based on the monitoring of the contextual conditions. The contextual triggers 116 can include a threat and/or a weapon. For example, the audio sensor 212 detects an audible contextual trigger in the form of an individual (e.g., a thief) threatening a device user of the mobile device 102 with bodily harm unless the device user provides the mobile device 102 to the individual. Alternatively or additionally, the visual sensor 214 detects a visual contextual trigger in the form of an individual (e.g., a thief) with a weapon.

At 406, a degradation protocol is performed limiting access to one or more functions of the mobile device based on an occurrence of the one or more contextual triggers. For example, the performance degradation manager 104 initiates to perform the degradation protocol 126 to limit access to one or more of the device functions 118 of the mobile device 102 based on the detected occurrence of the one or more contextual triggers. The mobile device 102, particularly the performance degradation manager 104, identifies the threat, the weapon, or both as the contextual triggers 116 that indicates a likelihood of a potential risk event 124. The performance degradation manager 104 then causes the mobile device 102 to initiate and perform a degradation protocol 126 based on these contextual triggers indicating the likelihood of the potential risk event.

At 408, the degradation protocol is nullified based on one or more subsequent contextual triggers indicating a lack of a potential risk event. For example, the performance degradation manager 104 nullifies the degradation protocol based on one or more subsequent contextual triggers indicating a lack of the potential risk event. The mobile device 102, particularly the performance degradation manager 104, causes the mobile device 102 to return to normal operation and functions based on the mobile device 102 being rebooted, or after a designated period of time.

FIG. 5 illustrates an example method 500 for mobile device access protection. The order in which the method is described is not intended to be construed as a limitation, and any number or combination of the described method operations may be performed in any order to perform a method, or an alternate method.

At 502, a mobile device stores multiple degradation modes configured to provide an appearance of one or more device features inoperability. For example, the mobile device includes a memory that stores the multiple degradation malfunctions 128 (e.g., the degradation modes) that can be initiated to provide an appearance of one or more device features inoperability. The performance degradation manager 104 monitors eh contextual conditions for any combination of audible contextual conditions 204, visible contextual conditions 206, locational contextual conditions 208, and/or personal contextual conditions 210. The monitoring is accomplished using any combinations of the audio sensor 212 (e.g., a microphone) of the mobile device 102, the visual sensor 214 (e.g., a camera) of the mobile device 102, the locational sensor 216 (e.g., a GPS) of the mobile device 102, and/or a personal sensor 218.

At 504, one or more contextual triggers are detected that indicate at least one potential risk event. For example, the performance degradation manager 104 detects one or more of the contextual triggers 116 that indicate a potential risk event 124 based on the monitoring of the various contextual conditions. The contextual triggers 116 include any combination of an audible contextual trigger, a visible contextual trigger, a locational contextual trigger, and/or a personal contextual trigger. For example, the visual sensor 214 senses a visible contextual trigger in the form of a weapon; the personal sensor 218 senses a personal contextual trigger in the form of an unusual elevation of heart rate; and the locational sensor 216 senses a locational contextual trigger in the form of the mobile device 102 being in a location of significant crime.

At 506, a degradation protocol is performed that initiates at least one of the multiple degradation modes to limit access to one or more functions of a mobile device. For example, the performance degradation manager 104 initiates to perform at least one of the multiple degradation malfunctions 128 (e.g., degradation modes) to limit access to one or more of the device functions 118 and/or device applications 110. The mobile device 102, particularly the performance degradation manager 104, analyzes the visible contextual trigger, the personal contextual trigger, and the locational contextual trigger with the initiation machine learning model. The initiation machine learning model determines that there is a likelihood of a potential risk event. In turn, the machine learning model, as part of the performance degradation manager 104, causes the mobile device 102 to initiate and perform a degradation protocol 126 based on the contextual triggers 116 indicating the likelihood of a potential risk event.

FIG. 6 illustrates various components of an example device 600, which can implement aspects of the techniques and features for mobile device access protection, as described herein. The example device 600 may be implemented as any of the devices described with reference to the previous FIGS. 1-5, such as any type of a wireless device, mobile device, mobile phone, flip phone, client device, companion device, display device, tablet, computing, communication, entertainment, gaming, media playback, and/or any other type of computing, consumer, and/or electronic device. For example, the mobile device 102 described with reference to FIGS. 1-5 may be implemented as the example device 600.

The example device 600 can include various, different communication devices 602 that enable wired and/or wireless communication of device data 604 with other devices. The device data 604 can include any of the various device's data and content that is generated, processed, determined, received, stored, and/or communicated from one computing device to another. Generally, the device data 604 can include any form of audio, video, image, graphics, and/or electronic data that is generated by applications executing on a device. The communication devices 602 can also include transceivers for cellular phone communication and/or for any type of network data communication.

The example device 600 can also include various, different types of data input/output (I/O) interfaces 606, such as data network interfaces that provide connection and/or communication links between the devices, data networks, and other devices. The data I/O interfaces 606 may be used to couple the device to any type of components, peripherals, and/or accessory devices, such as a computer input device that may be integrated with the example device 600. The I/O interfaces 606 may also include data input ports via which any type of data, information, media content, communications, messages, and/or inputs may be received, such as user inputs to the device, as well as any type of audio, video, image, graphics, and/or electronic data received from any content and/or data source.

The example device 600 includes a processor system 608 of one or more processors (e.g., any of microprocessors, controllers, and the like) and/or a processor and memory system implemented as a system-on-chip (SoC) that processes computer-executable instructions. The processor system 608 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 610. The example device 600 may also include any type of a system bus or other data and command transfer system that couples the various components within the device. A system bus can include any one or combination of different bus structures and architectures, as well as control and data lines.

The example device 600 also includes memory and/or memory devices 612 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 612 include volatile memory and non-volatile memory, fixed and removable media devices, and any suitable memory device or electronic data storage that maintains data for computing device access. The memory devices 612 can include various implementations of random-access memory (RAM), read-only memory (ROM), flash memory, and other types of storage media in various memory device configurations. The example device 600 may also include a mass storage media device.

The memory devices 612 (e.g., as computer-readable storage memory) provide data storage mechanisms, such as to store the device data 604, other types of information and/or electronic data, and various device applications 614 (e.g., software applications and/or modules). For example, an operating system 616 may be maintained as software instructions with a memory device 612 and executed by the processor system 608 as a software application. The device applications 614 may also include a device manager, such as any form of a control application, software application, signal-processing and control module, code that is specific to a particular device, a hardware abstraction layer for a particular device, and so on.

In this example, the device 600 includes a performance degradation manager 618 that implements various aspects of the described features and techniques described herein. The performance degradation manager 618 may be implemented with hardware components and/or in software as one of the device applications 614, such as when the example device 600 is implemented as the mobile device 102 described with reference to FIGS. 1-5. An example of the performance degradation manager 618 is the performance degradation manager 104 implemented by the mobile device 102, such as a software application and/or as hardware components in the mobile device. In implementations, the performance degradation manager 618 may include independent processing, memory, and logic components as a computing and/or electronic device integrated with the example device 600.

The example device 600 can also include a microphone 620 (e.g., to capture an audio recording) and/or camera devices 622 (e.g., to capture video images), as well as any type of device sensors 624, such as motion sensors that may be implemented as components of an inertial measurement unit (IMU). The device sensors 624 may be implemented with various sensors, such as a gyroscope, an accelerometer, and/or other types of motion sensors to sense motion of the device. The motion sensors can generate sensor data vectors having three-dimensional parameters (e.g., rotational vectors in x, y, and z-axis coordinates) indicating location, position, acceleration, rotational speed, and/or orientation of the device. The example device 600 can also include one or more power sources 626, such as when the device is implemented as a wireless device and/or mobile device. The power sources may include a charging and/or power system, and may be implemented as a flexible strip battery, a rechargeable battery, a charged super-capacitor, and/or any other type of active or passive power source.

The example device 600 can also include an audio and/or video processing system 628 that generates audio data for an audio system 630 and/or generates display data for a display system 632. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 600. Alternatively, the audio system and/or the display system are external, peripheral components to the example device.

Although implementations for mobile device access protection have been described in language specific to features and/or methods, the appended claims are not necessarily limited to the specific features or methods described. Rather, the specific features and methods are disclosed as example implementations for mobile device access protection, and other equivalent features and methods are intended to be within the scope of the appended claims. Further, various examples are described, and it is to be appreciated that each described example may be implemented independently or in connection with one or more other described examples. Additional aspects of the techniques, features, and/or methods discussed herein relate to one or more of the following:

A mobile device, comprising: at least one processor coupled with a memory and a performance degradation manager configured to cause the mobile device to: detect one or more contextual triggers indicating at least one potential risk event; and perform, based on the one or more contextual triggers, a degradation protocol limiting access to one or more functions of the mobile device, the one or more functions normally providing access to at least one of personal information or device application access.

Alternatively, or in addition to the above-described mobile device, any one or combination of: the at least one potential risk event is an unauthorized attempt to access an application that allows money to be transferred. The one or more contextual triggers include at least one of an audible contextual trigger, a visual contextual trigger, a locational contextual trigger, or a personal contextual trigger. The degradation protocol includes an appearance of a malfunction selected from at least one of an application update, a touchscreen malfunction, a display malfunction, a connection malfunction, a power failure, or a redirection. To perform the degradation protocol, the performance degradation manager is configured to cause the mobile device to select at least one of multiple degradation malfunctions based on the one or more contextual triggers that are detected. The performance degradation manager is configured to cause the mobile device to nullify the degradation protocol based on one or more subsequent contextual triggers indicating a lack of the potential risk event. The one or more subsequent contextual triggers include at least one of a low-risk location or securing of the at least one personal information or device application access. To detect the one or more contextual triggers, the performance degradation manager is configured to cause the mobile device to analyze, using a trained machine learning module, contextual conditions to determine a likelihood of the at least one potential risk event. The performance degradation manager is configured to cause the mobile device to detect the one or more contextual triggers by at least one of a microphone of the mobile device, a camera of the mobile device, or a geolocation feature of the mobile device.

A method, comprising: monitoring contextual conditions associated with a mobile device; detecting, based on the monitoring of the contextual conditions, one or more contextual triggers indicating at least one potential risk event; and performing, based on an occurrence of the one or more contextual triggers, a degradation protocol limiting access to one or more functions of the mobile device, the one or more functions normally providing access to at least one of personal information or device application access.

Alternatively, or in addition to the above-described method, any one or combination of: the one or more contextual triggers include at least one of an audible contextual trigger, a visual contextual trigger, a locational contextual trigger, or a personal contextual trigger. The degradation protocol includes an appearance of a malfunction selected from at least one of an application update, a touchscreen malfunction, a display malfunction, a connection malfunction, a power failure, or a redirection. The degradation protocol selects at least one of multiple degradation malfunctions based on the one or more contextual triggers that are detected. The method further comprising nullifying the degradation protocol based on one or more subsequent contextual triggers indicating a lack of the potential risk event. The one or more subsequent contextual triggers include at least one of a low-risk location or securing of the at least one personal information or device application access. The detecting of the one or more contextual triggers includes analyzing, using a trained machine learning module, the contextual conditions to determine a likelihood of the at least one potential risk event. The one or more contextual triggers are detected by at least one of a microphone of the mobile device, a camera of the mobile device, or a geolocation feature of the mobile device.

A system, comprising: a memory to store multiple degradation modes configured to provide an appearance of one or more device features inoperability; and a processor configured to execute a performance degradation manager to cause the system to: detect one or more contextual triggers indicating at least one potential risk event; and perform, based on the one or more contextual triggers, a degradation protocol that initiates at least one of the multiple degradation modes to limit access to one or more functions of a mobile device, the one or more functions normally providing access to at least one of personal information or device application access.

Alternatively, or in addition to the above-described system, any one or combination of: to detect the one or more contextual triggers, the performance degradation manager is configured to cause the system to analyze, using a trained machine learning module, contextual conditions to determine a likelihood of the at least one potential risk event. The degradation protocol includes at least one of an application update, a touchscreen malfunction, a display malfunction, a connection malfunction, a power failure, or a redirection.

1. A mobile device, comprising:
at least one processor coupled with a memory; and
a performance degradation manager configured to cause the mobile device to:
detect one or more contextual triggers indicating at least one potential risk event; and
perform, based on the one or more contextual triggers, a degradation protocol limiting access to one or more functions of the mobile device, the one or more functions normally providing access to at least one of personal information or device application access.

2. The mobile device of claim 1, wherein the at least one potential risk event is an unauthorized attempt to access an application that allows money to be transferred.

3. The mobile device of claim 1, wherein the one or more contextual triggers include at least one of an audible contextual trigger, a visual contextual trigger, a locational contextual trigger, or a personal contextual trigger.

4. The mobile device of claim 1, wherein the degradation protocol includes an appearance of a malfunction selected from at least one of an application update, a touchscreen malfunction, a display malfunction, a connection malfunction, a power failure, or a redirection.

5. The mobile device of claim 1, wherein, to perform the degradation protocol, the performance degradation manager is configured to cause the mobile device to select at least one of multiple degradation malfunctions based on the one or more contextual triggers that are detected.

6. The mobile device of claim 1, wherein the performance degradation manager is configured to cause the mobile device to nullify the degradation protocol based on one or more subsequent contextual triggers indicating a lack of the potential risk event.

7. The mobile device of claim 6, wherein the one or more subsequent contextual triggers include at least one of a low-risk location or securing of the at least one personal information or device application access.

8. The mobile device of claim 1, wherein, to detect the one or more contextual triggers, the performance degradation manager is configured to cause the mobile device to analyze, using a trained machine learning module, contextual conditions to determine a likelihood of the at least one potential risk event.

9. The mobile device of claim 1, wherein the performance degradation manager is configured to cause the mobile device to detect the one or more contextual triggers by at least one of a microphone of the mobile device, a camera of the mobile device, or a geolocation feature of the mobile device.

10. A method, comprising:
monitoring contextual conditions associated with a mobile device;
detecting, based on the monitoring of the contextual conditions, one or more contextual triggers indicating at least one potential risk event; and
performing, based on an occurrence of the one or more contextual triggers, a degradation protocol limiting access to one or more functions of the mobile device, the one or more functions normally providing access to at least one of personal information or device application access.

11. The method of claim 10, wherein the one or more contextual triggers include at least one of an audible contextual trigger, a visual contextual trigger, a locational contextual trigger, or a personal contextual trigger.

12. The method of claim 10, wherein the degradation protocol includes an appearance of a malfunction selected from at least one of an application update, a touchscreen malfunction, a display malfunction, a connection malfunction, a power failure, or a redirection.

13. The method of claim 10, wherein the degradation protocol selects at least one of multiple degradation malfunctions based on the one or more contextual triggers that are detected.

14. The method of claim 10, further comprising nullifying the degradation protocol based on one or more subsequent contextual triggers indicating a lack of the potential risk event.

15. The method of claim 14, wherein the one or more subsequent contextual triggers include at least one of a low-risk location or securing of the at least one personal information or device application access.

16. The method of claim 10, wherein the detecting of the one or more contextual triggers includes analyzing, using a trained machine learning module, the contextual conditions to determine a likelihood of the at least one potential risk event.

17. The method of claim 10, wherein the one or more contextual triggers are detected by at least one of a microphone of the mobile device, a camera of the mobile device, or a geolocation feature of the mobile device.

18. A system, comprising:
a memory to store multiple degradation modes configured to provide an appearance of one or more device features inoperability; and
a processor configured to execute a performance degradation manager to cause the system to:
detect one or more contextual triggers indicating at least one potential risk event; and
perform, based on the one or more contextual triggers, a degradation protocol that initiates at least one of the multiple degradation modes to limit access to one or more functions of a mobile device, the one or more functions normally providing access to at least one of personal information or device application access.

19. The system of claim 18, wherein, to detect the one or more contextual triggers, the performance degradation manager is configured to cause the system to analyze, using a trained machine learning module, contextual conditions to determine a likelihood of the at least one potential risk event.

20. The system of claim 18, wherein the degradation protocol includes at least one of an application update, a touchscreen malfunction, a display malfunction, a connection malfunction, a power failure, or a redirection.
